(19) United States
(12) Patent Application Publication
(10) Pub. No.: US 2025/0253476 A1
(43) Pub. Date: Aug. 7, 2025

(54) TRACTION BATTERY ARRAY ROUNDED ENDPLATE AND BATTERY ARRAY WRAPPING METHOD

(71) Applicant: Ford Global Technologies, LLC, Dearborn, MI (US)

(72) Inventors: Justin Purewal, Ann Arbor, MI (US); Andrew Robert Drews, Ann Arbor, MI (US); Matthew Denlinger, Ferndale, MI (US); Brian Joseph Robert, Saint Clair Shores, MI (US)

(21) Appl. No.: 18/430,921

(22) Filed: Feb. 2, 2024

(51) Int. Cl. H01M 50/291; H01M 10/04; H01M 50/244; H01M 50/249; H01M 50/293

(52) U.S. Cl. CPC H01M 50/291; H01M 10/0481; H01M 50/244; H01M 50/249; H01M 50/293; H01M 2220/20

(57) ABSTRACT

A traction battery assembly includes a plurality of battery cells disposed along an array axis, a rounded endplate at an axial end of the plurality of battery cells, and a wrap spanning the rounded endplate. A method of securing a battery array includes positioning a plurality of battery cells between along an array axis between a first rounded endplate and a second rounded endplate, and compressing the plurality of battery cells between the first and second rounded endplates by winding a wrap around the first rounded endplate, the plurality of battery cells, and the second rounded endplate.

### TECHNICAL FIELD

This disclosure relates generally to an endplate of a traction battery and, more particularly, to an endplate that can be wrapped with other components of the traction battery.

### BACKGROUND

Electrified vehicles differ from conventional motor vehicles because electrified vehicles are selectively driven using one or more electric machines powered by a traction battery. The electric machines can drive the electrified vehicles instead of, or in addition to, an internal combustion engine. A traction battery of an electrified vehicle can include a plurality of battery cell assemblies arranged in one or more battery arrays with an enclosure.

### SUMMARY

In some aspects, the techniques described herein relate to a traction battery assembly, including: a plurality of battery cells disposed along an array axis; a rounded endplate at an axial end of the plurality of battery cells; and a wrap spanning the rounded endplate.

In some aspects, the techniques described herein relate to an assembly, wherein a first side of the rounded endplate faces away from the plurality of battery cells, and an opposite, second side of the rounded endplate faces toward the plurality of battery cells, wherein the first side is rounded relative to the second side.

In some aspects, the techniques described herein relate to an assembly, wherein the first side is rounded about a first axis that is perpendicular to the array axis.

In some aspects, the techniques described herein relate to an assembly, wherein the first side is rounded about a second axis that is perpendicular to both the first axis and the array axis.

In some aspects, the techniques described herein relate to an assembly, wherein the rounded endplate has a vertically upper edge opposite a vertically lower edge, the rounded endplate rounded continuously from the vertically upper edge to the vertically lower edge.

In some aspects, the techniques described herein relate to an assembly, wherein the rounded endplate further includes respective first and second outboard edges that each extend from the vertically upper edge to the vertically lower edge, the rounded endplate rounded continuously from the first outboard edge to the second outboard edge.

In some aspects, the techniques described herein relate to an assembly, wherein the wrap comprises a curable material.

In some aspects, the techniques described herein relate to an assembly, wherein the wrap is a tape that is polymer-based with fiber reinforcement.

In some aspects, the techniques described herein relate to an assembly, wherein the wrap is wound around the plurality of battery cells and the rounded endplate.

In some aspects, the techniques described herein relate to an assembly, wherein the rounded endplate is a first rounded endplate, and further including a second rounded endplate that is spanned by the wrap.

In some aspects, the techniques described herein relate to an assembly, wherein the wrap is wound around the first rounded endplate, the plurality of battery cells, and the second rounded endplate to compress the plurality of battery cells between the first and second rounded endplates.

In some aspects, the techniques described herein relate to an assembly, further including a traction battery of an electrified vehicle, the traction battery having the plurality of battery cells and the endplate.

In some aspects, the techniques described herein relate to an assembly, wherein the rounded endplate is a polymer-based material.

In some aspects, the techniques described herein relate to an assembly, wherein the rounded endplate is a composite-based material.

In some aspects, the techniques described herein relate to a method of securing a battery array, including: positioning a plurality of battery cells between along an array axis between a first rounded endplate and a second rounded endplate; and compressing the plurality of battery cells between the first and second rounded endplates by winding a wrap around the first rounded endplate, the plurality of battery cells, and the second rounded endplate.

In some aspects, the techniques described herein relate to a method, wherein the wrap spans a profile of the first rounded endplate, the profile rounded continuously from a first edge of the first rounded endplate to an opposing second edge of the first rounded endplate.

In some aspects, the techniques described herein relate to a method, wherein the first and second edges are outboard edges such that the first rounded endplate is curved about a vertically extending axis.

In some aspects, the techniques described herein relate to a method, wherein the first rounded endplate is additionally curved about a horizontally extending axis.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a partially schematic and side view of an electrified vehicle having a traction battery pack.

FIG. 2 illustrates an expanded view of the traction battery pack of FIG. 1.

FIG. 3 illustrates a side view of a battery array from the traction battery pack of FIG. 2 as a wrap is wound around battery cells and endplates of the battery array.

FIG. 4 illustrates a perspective view of an endplate from the battery array of FIG. 3.

FIG. 5 illustrates a section view at line 5-5 in FIG. 4.

FIG. 6 illustrates a section view at line 6-6 in FIG. 4.

FIG. 7 illustrates a rounded endplate according to another exemplary aspect of the present disclosure.

FIG. 8 illustrates a section view at line 8-8 in FIG. 7.

FIG. 9 illustrates an battery array wrapped according to another exemplary aspect of the present disclosure.

### DETAILED DESCRIPTION

This disclosure relates generally to a traction battery pack for an electrified vehicle and, in particular, to securing a battery array of the traction battery pack in a way that facilitates applying even pressure to battery cells of the battery array.

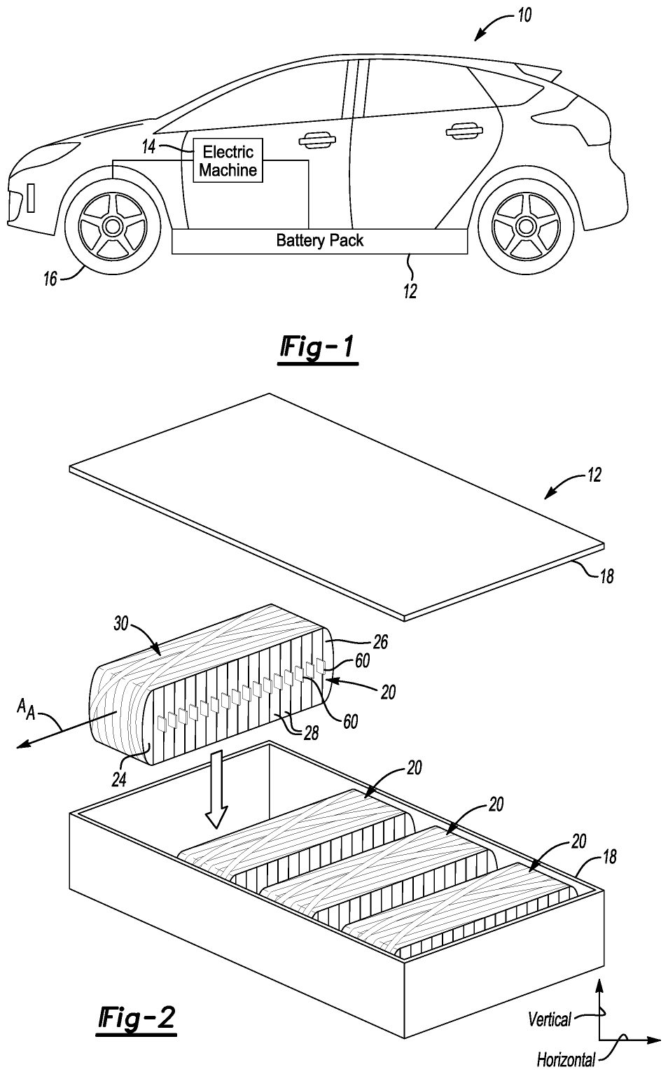

With reference to FIG. 1, an electrified vehicle 10 includes a traction battery pack 12, an electric machine 14, and wheels 16. The battery pack 12 powers the electric machine 14, which can convert electric power to torque to drive the wheels 16. The battery pack 12 is a traction battery pack as the battery pack 12 is used for propulsion.

The battery pack 12 is, in the exemplary embodiment, secured to an underbody of the electrified vehicle 10. The battery pack 12 could be located elsewhere on the electrified vehicle 10 in other examples.

The example vehicle 10 is a battery electric vehicle (BEV). In another example, the vehicle 10 could be another type of electrified vehicle, such as a hybrid electric vehicle (HEV), plug-in hybrid electric vehicle (PHEV), or a conventional vehicle. A hybrid electric vehicle selectively drives wheels using torque provided by an internal combustion engine instead of, or in addition to, an electric machine. Generally, the electrified vehicle 10 could be any type of vehicle having a traction battery pack.

Referring now to FIGS. 2 and 3, the battery pack 12 includes a battery pack enclosure assembly 18 and a plurality of battery arrays 20. The enclosure assembly 18 provides an interior 22 that houses the battery arrays 20.

In the exemplary embodiment, the battery arrays 20 each include a first rounded endplate 24, a second rounded endplate 26, and a plurality of battery cells 28 disposed along an array axis AA. The first rounded endplate 24 and the second rounded endplate 26 are disposed at opposing axial ends of the plurality of battery cells 28.

In this example, a wrap 30 is wound around the first rounded endplate 24, the second rounded endplate 26, and the plurality of battery cells 28. The wrap 30 compresses the first rounded endplate 24 toward the second rounded endplate 26 to compress the plurality of battery cells 28.

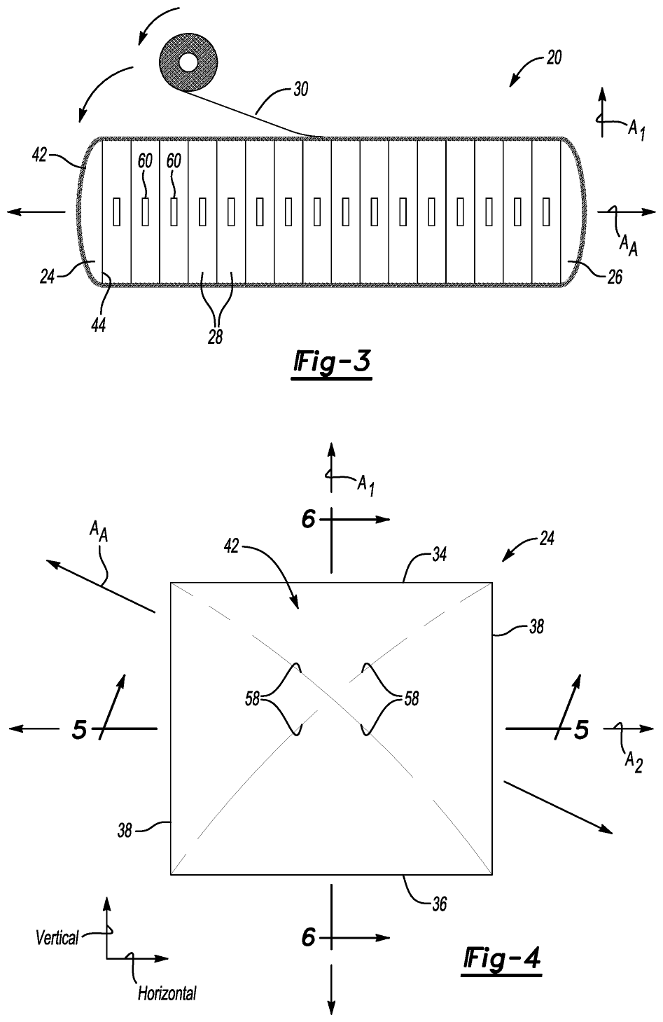

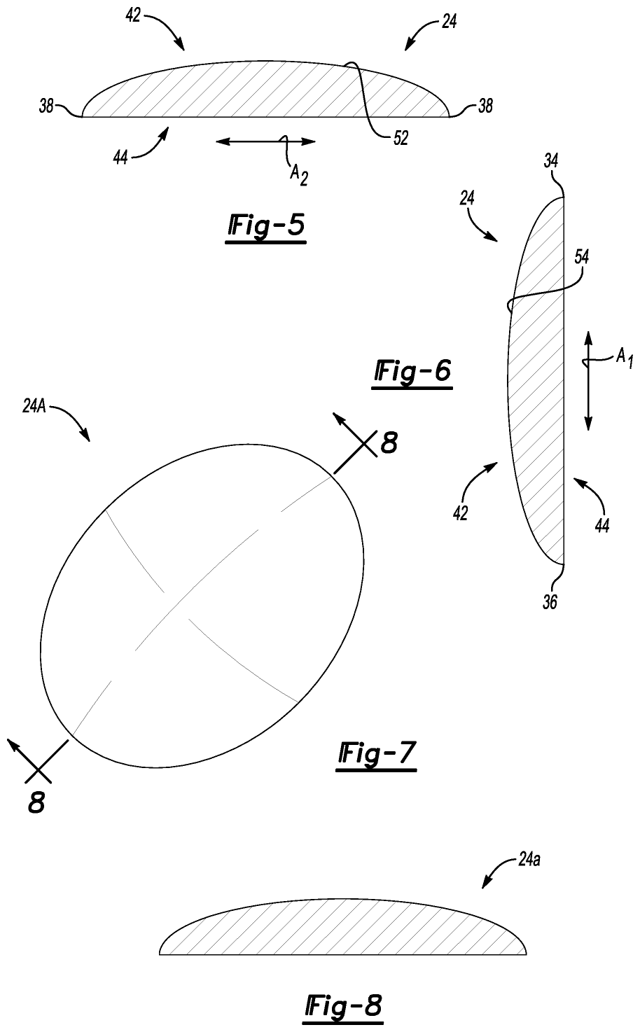

In the exemplary embodiment, with reference to FIGS. 4-6 and continuing reference to FIGS. 2 and 3, the first rounded endplate 24 has a vertically upper edge 34, a vertically lower edge 36, and a pair of outboard edges 38 extending from the vertically upper edge 34 to the vertically lower edge 36.

A rounded side 42 of the first rounded endplate 24 faces away from the plurality of battery cells 28 when installed within the battery array 20. An opposite flat side 44 of the first rounded endplate 24 faces the plurality of battery cells 28 when installed within the battery pack 12. The rounded side 42 is rounded relative to the flat side 44. The flat side 44 is planar in this example.

On the rounded side 42, a contour 52 of a horizontal section through the first rounded endplate 24 is rounded continuously from one of the outboard edges 38 to the other of the outboard edges 38. The contour 52 of the horizontal section is curved about a first axis A₁ that is perpendicular to the array axis AA. The first axis A₁ is a vertically extending axis in this example.

A profile that is rounded continuously from an edge to a opposite edge is, as can be appreciated, different than a profile that includes distinct planar areas meeting at a rounded corner. In such an example, the rounding would not extend continuously from edge to edge.

On the rounded side 42, a contour 54 of a vertical section through the first rounded endplate 24 is rounded continuously from the vertically upper edge 34 to the vertically lower edge 36. The contour 54 of the vertical section is curved about a second axis A₂ that is perpendicular to both the array axis AA and the first axis A₁. The second axis A₂ is a horizontally extending axis in this example.

The first rounded endplate 24 includes at least one vertical contour through the rounded side 42 that is rounded continuously, and at least one horizontal contour though the rounded side 42 that is rounded continuously.

Contours of the flat side 44 of the first rounded endplate are substantially linear in this example.

The second rounded endplate 26 is constructed similarly to the first rounded endplate 24. The second rounded endplate 26 is rotated 180 degrees relative to the first rounded endplate 24 when installed within the battery array 20.

The wrap 30 is wound around the first rounded endplate 24, the battery cells 28, and the second rounded endplate 26. The wrap 30 spans the rounded side 42 of the first rounded endplate 24, and the rounded side of the second rounded endplate 26. The wrap 30 is wound around the first rounded endplate 24, the plurality of battery cells 28, and the second rounded endplate 26 to compress the plurality of battery cells 28 axially between the first rounded endplate 24 and the second rounded endplate 26.

The wrap 30 can be wound around the first rounded endplate 24, the battery cells 28, and the second rounded endplate 26 while the first rounded endplate 24 and the second rounded endplate 26 are held in a position compressing the battery cells 28. The first rounded endplate 24 and the second rounded endplate 26 can be held by external clamps or fixtures.

The wrap 30 can be a curable material. The wrap 30 can be a tape that is fiber reinforced and polymer-based. In some examples, the wrap 30 is a carbon-fiber composite overwrap having a relatively high tensile strength. The carbon fiber can be embedded in an epoxy matrix. In some examples, the carbon fibers could be substituted with glass fibers.

The wrap 30 can be a thermoset epoxy polymer with a relatively low curing temperature.

As the wrap 30 spans over rounded first sides of the first rounded endplate 24 and the second rounded endplate 26, the force applied by the wrap 30 to the first rounded endplate 24 and the second rounded endplate 26 is distributed through the first rounded endplates 24 and the second rounded endplates 26. Distributing the force can help to inhibit. In the past, a wrap could be faces with focused areas of stress if the wrap spanned over an abrupt corner area of an endplate.

Using the wrap 30 with the first rounded endplate 24 and the second rounded endplate 26 can provide a more uniform compression to the plurality of battery cells 28 along the array axis AA than if the wrap 30 spanned endplates that were not rounded.

Relatively uniform compression, and high compression loads, can be particularly useful if the plurality of battery cells 28 are solid state battery cells. Relatively uniform compression, and lack of overhang between endplates and battery cells, can also facilitate use of thinner endplate and using a relatively lighter weight endplates.

In some examples, the first rounded endplate 24 and the second rounded endplate 26 can be a polymer-based material. The first rounded endplate 24 and the second rounded endplate 26 do not have to extend outward from the array axis AA.

The example first rounded endplate 24 can have some corners 58 where the contour 54 interfaces with the contour 52, but angle of the corners 58 is obtuse and more than 120° in some examples.

As shown in FIGS. 7 and 8, in another example, a rounded endplate 24A can, in some examples, be hemispherical or dome-shaped and the corners 58 are omitted. The rounded endplate 24A has a circular profile.

In some examples, the wrap 30 can be wrapped about a thermal exchange plate in addition to the first rounded endplate 24, the battery cells 28, and the second rounded endplate 26. In some examples, the first rounded endplate 24, the second rounded endplate 26, or both are thermal exchange plates.

The wrap 30 can be wrapped about sides of the battery cells 28 lacking terminals 60 as shown in FIGS. 2 and 3. In this example, the terminals 60 are tab terminals projecting horizontally from the array 20.

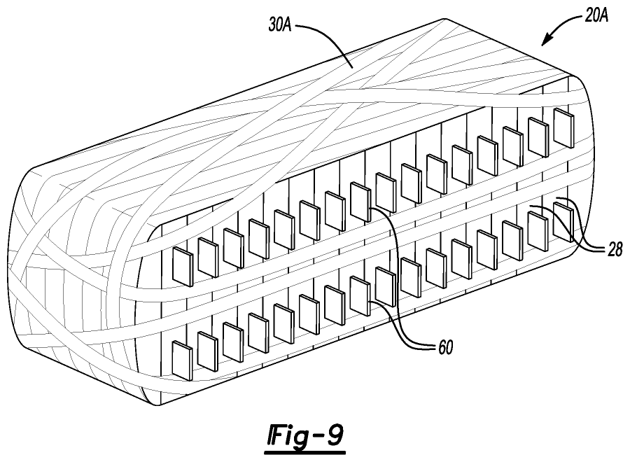

In other arrays 20A, a wrap 30A can instead or additionally be wrapped about sides of the battery cells 28 having the terminals 60 as shown in FIG. 9. When wrapped about the sides of the battery cells 28 having the terminals 60, the wrap 30 can be routed to leave spaced for the terminals 60 to project outward and coupled to a busbar, for example.

In the examples of this disclosure, the wrap 30 may be a dielectric or coated with a dielectric. In other examples, a dielectric shield can be positioned between the wrap 30 and areas of the traction battery pack 12, particularly in the areas near the terminals 60.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery assembly, comprising:
a plurality of battery cells disposed along an array axis;
a rounded endplate at an axial end of the plurality of battery cells; and
a wrap spanning the rounded endplate.

2. The assembly of claim 1, wherein a first side of the rounded endplate faces away from the plurality of battery cells, and an opposite, second side of the rounded endplate faces toward the plurality of battery cells, wherein the first side is rounded relative to the second side.

3. The assembly of claim 2, wherein the first side is rounded about a first axis that is perpendicular to the array axis.

4. The assembly of claim 3, wherein the first side is rounded about a second axis that is perpendicular to both the first axis and the array axis.

5. The assembly of claim 1, wherein the rounded endplate has a vertically upper edge opposite a vertically lower edge, the rounded endplate rounded continuously from the vertically upper edge to the vertically lower edge.

6. The assembly of claim 5, wherein the rounded endplate further includes respective first and second outboard edges that each extend from the vertically upper edge to the vertically lower edge, the rounded endplate rounded continuously from the first outboard edge to the second outboard edge.

7. The assembly of claim 1, wherein the wrap comprises a curable material.

8. The assembly of claim 1, wherein the wrap is a tape that is polymer-based with fiber reinforcement.

9. The assembly of claim 1, wherein the wrap is wound around the plurality of battery cells and the rounded endplate.

10. The assembly of claim 1, wherein the rounded endplate is a first rounded endplate, and further comprising a second rounded endplate that is spanned by the wrap.

11. The assembly of claim 10, wherein the wrap is wound around the first rounded endplate, the plurality of battery cells, and the second rounded endplate to compress the plurality of battery cells between the first and second rounded endplates.

12. The assembly of claim 1, further comprising a traction battery of an electrified vehicle, the traction battery having the plurality of battery cells and the endplate.

13. The assembly of claim 1, wherein the rounded endplate is a polymer-based material.

14. The assembly of claim 1, wherein the rounded endplate is a composite-based material.

15. A method of securing a battery array, comprising:
positioning a plurality of battery cells between along an array axis between a first rounded endplate and a second rounded endplate; and
compressing the plurality of battery cells between the first and second rounded endplates by winding a wrap around the first rounded endplate, the plurality of battery cells, and the second rounded endplate.

16. The method of claim 15, wherein the wrap spans a profile of the first rounded endplate, the profile rounded continuously from a first edge of the first rounded endplate to an opposing second edge of the first rounded endplate.

17. The method of claim 16, wherein the first and second edges are outboard edges such that the first rounded endplate is curved about a vertically extending axis.

18. The method of claim 17, wherein the first rounded endplate is additionally curved about a horizontally extending axis.
